(19) United States
(12) Patent Application Publication
(10) Pub. No.: US 2024/0418610 A1
(43) Pub. Date: Dec. 19, 2024

(54) GAS ANALYSIS SYSTEMS FOR BATTERY CELLS

(71) Applicant: GM GLOBAL TECHNOLOGY OPERATIONS LLC, Detroit, MI (US)

(72) Inventors: Erik Damon HUEMILLER, Troy, MI (US); Thomas A. YERSAK, Royal Oak, MI (US); James R. SALVADOR, East Lansing, MI (US); Dmitriy BRUDER, Clinton Twp., MI (US); Thaddeus EZEH, Rochester Hills, MI (US)

(21) Appl. No.: 18/334,676

(22) Filed: Jun. 14, 2023

(51) Int. Cl. G01N 1/22; G01N 1/24; H01M 10/48; H01M 50/317

(52) U.S. Cl. CPC G01N 1/2226; G01N 1/24; H01M 10/48; H01M 50/317

(57) ABSTRACT

A battery cell gas analysis system including a degas chamber, a vacuum pump in fluid communication with the degas chamber to remove air from the degas chamber, a venting port configured to selectively vent the degas chamber, a battery cell enclosed in the degas chamber, and a gas detector in fluid communication with the degas chamber. The gas detector is configured to detect, with gas species separation, at least one parameter of a gas released from the battery cell into the degas chamber, and the at least one parameter of the gas of the battery cell is indicative of a manufacturing quality of the battery cell. The system includes at least one valve coupled between the degas chamber and the gas detector to selectively control a flow of the gas of the battery cell to the gas detector.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure generally relates to gas analysis systems for battery cells, including gas detectors for detecting gas released from a battery cell pouch during manufacturing or testing of the battery cell.

Vehicles may use battery cells to power various aspects of the vehicle. Increasing production yields and volumes of vehicle battery cells being manufactured drives a need for improved battery cell quality verification measures. Quality verification of battery cells currently takes place at the end of the battery cell manufacturing line, where significant time and materials have been invested in making non-conforming battery cells.

### SUMMARY

A battery cell gas analysis system including a degas chamber, a vacuum pump in fluid communication with the degas chamber to remove air from the degas chamber, a venting port configured to selectively vent the degas chamber, a battery cell enclosed in the degas chamber, and a gas detector in fluid communication with the degas chamber. The gas detector is configured to detect, with gas species separation, at least one parameter of a gas released from the battery cell into the degas chamber, and the at least one parameter of the gas of the battery cell is indicative of a manufacturing quality of the battery cell. The system includes at least one valve coupled between the degas chamber and the gas detector to selectively control a flow of the gas of the battery cell to the gas detector.

In other features, the battery cell is a pouch cell, and the battery cell gas analysis system further includes a puncturing knife configured to puncture a pouch of the battery cell to release a gas of the battery cell into the degas chamber, and a heat seal bar configured to seal the pouch of the battery cell after release of the gas of the battery cell.

In other features, the system includes at least one of a constriction channel and a pressure control value coupled between the degas chamber and the gas detector to reduce a pressure of the gas of the battery cell flowing to the gas detector.

In other features, the system includes a sample storage chamber coupled between the degas chamber and the gas detector to receive the gas of the battery cell prior to the gas of the battery cell flowing to the gas detector.

In other features, the gas detector is a first gas detector, and the battery cell gas analysis system further includes a gas flow line extending from the sample storage chamber, and a second gas detector in fluid communication with the gas flow line, the second gas detector configured to detect at least one parameter of the gas of the battery cell with gas species separation.

In other features, the system includes a sample bottle port in fluid communication with the sample storage chamber, the sample bottle port configured to removably couple with a sample bottle to flow the gas of the battery cell into the sample bottle to remove at least a portion of the gas of the battery cell from the battery cell gas analysis system.

In other features, the gas detector is in fluid communication with the degas chamber via a first gas flow line, the gas detector is in fluid communication with the sample storage chamber via a second gas flow line, and the first gas flow line is separate from the second gas flow line.

In other features, the gas detector is in fluid communication with a gas sampling tube extending into the degas chamber, and an opening of the gas sampling tube is adjacent to a puncture location of a pouch of the battery cell.

In other features, the system includes a gas purge line in fluid communication with the gas detector to supply a purge gas to clean the gas detector after analyzing the gas of the battery cell.

In other features, the gas detector is a first gas detector, and the battery cell gas analysis system further includes a sensor suite including one or more additional gas detectors configured to analyze the gas of the battery cell with gas species resolution, and a gas handling module configured to receive the gas of the battery cell from the degas chamber and flow the gas of the battery cell past the sensor suite.

In other features, the gas detector is a first gas detector configured to detect a first parameter of the gas of the battery cell, the battery cell gas analysis system includes a second gas detector in fluid communication with the degas chamber, the second gas detector configured to detect a second parameter of the gas of the battery cell with gas species separation, and the second parameter is different than the first parameter.

In other features, the gas detector includes a mass spectrometer. In other features, the gas detector includes a gas chromatography system. In other features, gas detector includes an infrared absorption spectroscopy system.

A battery cell gas analysis system includes a degas chamber, a vacuum pump in fluid communication with the degas chamber to remove air from the degas chamber, a battery cell enclosed in the degas chamber, a gas detector in fluid communication with the degas chamber, the gas detector configured to detect at least one parameter of gas of the battery cell with gas species separation, the at least one parameter of the gas of the battery cell indicative of a manufacturing quality of the battery cell, and at least one valve coupled between the degas chamber and the gas detector to selectively control a flow of the gas of the battery cell to the gas detector.

In other features, the gas detector includes at least one of a mass spectrometer, a gas chromatography system or an infrared absorption system. In other features, the system includes at least one of a constriction channel and a pressure control coupled between the degas chamber and the gas detector to reduce a pressure of the gas of the battery cell flowing to the gas detector.

In other features, the system includes a sample storage chamber coupled between the degas chamber and the gas detector to receive the gas of the battery cell prior to the gas of the battery cell flowing to the gas detector.

A battery cell gas analysis system includes a degas chamber, a venting port configured to selectively vent the degas chamber, a gas detector in fluid communication with the degas chamber, the gas detector configured to detect, with gas species separation, at least one parameter of a gas released from a battery cell into the degas chamber, the at least one parameter of the gas of the battery cell indicative of a manufacturing quality of the battery cell, and at least one valve coupled between the degas chamber and the gas detector to selectively control a flow of the gas of the battery cell to the gas detector.

In other features, the gas detector includes at least one of a mass spectrometer, a gas chromatography system or an infrared absorption system.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example embodiment of a gas analysis system for battery cells.

FIG. 2 is a functional block diagram of an example embodiment of a gas analysis system for battery cells including a pressure control valve.

FIG. 3 is a functional block diagram of an example embodiment of a gas analysis system for battery cells including a sample gas chamber and a sensor suite.

FIG. 4 is a functional block diagram of an example embodiment of a gas analysis system for battery cells including a removable sample bottle port.

FIG. 5 is a functional block diagram of an example embodiment of a gas analysis system for battery cells including a lab air purge line.

FIG. 6 is a functional block diagram of an example embodiment of a gas analysis system for battery cells including a constriction line.

In the drawings, reference numbers may be reused to identify similar and/or identical elements.

### DETAILED DESCRIPTION

Some example embodiments include system for analyzing a composition of gas produced during the formation process of battery cells during manufacturing, using gas detectors which are configured to detect gas composition separability. Although some example embodiments are described herein with reference to vehicle battery cells, other example embodiments may include battery cells for electronics, grid storage, locomotives, boats, etc. Example gas detectors may include a mass spectrometer (e.g., a residual gas analyzer (RGA)), a gas chromatography system, an infrared (IR) absorption spectrometer, etc. An RGA may or may not include a dedicated vacuum pump, such as a turbo vacuum pump in an RGA mass spectrometer.

Different machine configurations may enable use of the gas detectors to analyze the gas of battery cells at high rates desired or required in vehicle battery cell manufacturing (or manufacturing of other battery cell types). Some example embodiments may reduce the amount of time needed at the end of line testing during vehicle battery cell manufacturing. For example, some gas detection systems described herein may reduce a cycle time of gas detection compared to, e.g., metal oxide sensors, while also facilitating gas composition analysis. For example, metal oxide detectors may provide very fast response times, but may not be capable of providing a desired level of gas composition detection for proper analysis. A large component of cycle time may include a time needed to get a gas into a form in which a sensor can analyze the gas. For metal oxide sensors, this would typically require dilution to prevent the sensor from saturating. For an RGA/MS sensor, the system may keep the vacuum level low enough to avoid flooding the analyzer, which may result in long pump-down times for reset. For IR and GC sensors, the system may get the gas to just above ambient pressure, so the gas can be introduced to respective sample chambers.

Formation quality of vehicle battery cells may be checked using various suitable testing methods, such as a dQ/dV and dV/dQ analysis to identify separate defects based on signal analysis of a first charging sequence, gas volume measurement where a machine vision system is used to measure gas volume, and gas composition analysis. Gas composition analysis may include, for example, a metal oxide high-rate sensor for high-rate detection of volatile organics, micro gas chromatography for secondary analysis of gas composition, etc. For example, in many battery cells that use carbonate based electrolytes (e.g., most commercially available Li-ion cells), the formation gases observed include H₂, CO, CO₂, methane ethane, ethylene, propane/propene (e.g., if they use propylene carbonate), or butenes.

Example sensors for vehicle battery cell gas analysis may include, but are not limited to, an SGX metal oxide detector, an oxygen (O₂) or nitrous oxide (NOX) detector, a hydrogen (H₂) detector, a pressure sensor, a mass spectrometer (RGA) detector, a micro gas chromatography detector, an IR absorption detector, etc. The gas detectors may be configured to detect any suitable components of gas of a vehicle battery cell, such as nitrogen dioxide, hydrogen, carbon monoxide, methane, ethylene, ethane, ammonia, ethanol, propane, iso-butane, carbon dioxide, etc.

During formation of vehicle battery cells, gases are produced as a byproduct of the decomposition of electrolyte solvents, salts and additives. Gas composition and volume in the vehicle battery cell (e.g., in a sealed pouch of the vehicle battery cell), may be directly related to a quality of the additive package chemistry, such as poor additives leading to increased gas volume and increase hydrocarbon gas production.

Example gas analysis implementations described herein may occur at any suitable time period during the manufacturing process for formation of the vehicle battery cell. For example, gas of the vehicle battery cell may be released and analyzed after pre-aging of the vehicle battery cell, after jig formation, after an aging process, after degassing, etc. For example, in order to be useful the gas analysis may be performed after some electrochemical reactions take place. In some example embodiments, a minimum cell potential is in the 3.5 V range. Below that value, the SEI may not be formed and very little gas, if any, may be available for analysis.

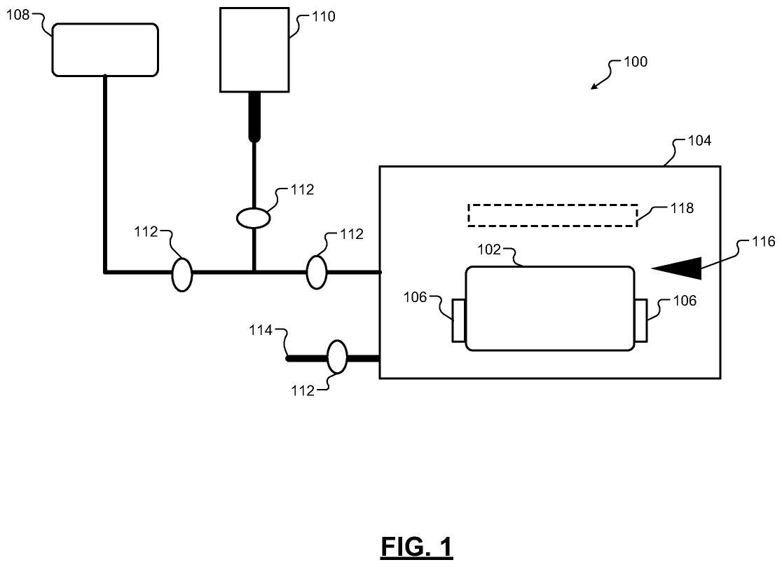

FIG. 1 is a functional block diagram of an example embodiment of a gas analysis system 100 for battery cells (such as vehicle battery cells or other types of battery cells). As shown in FIG. 1, the gas analysis system 100 includes a vehicle battery cell 102 enclosed in a degas chamber 104. The vehicle battery cell 102 includes electrical conductors 106 for electrically connecting the vehicle battery cell 102 to one or more power systems of a vehicle once the vehicle battery cell 102 is installed. Although some example embodiments are described herein with reference to a vehicle battery cell 102, other example embodiments may include other battery cell types such as battery cells for electronics, grid storage, locomotives, boats, etc.

The vehicle battery cell 102 may include a sealed battery pouch containing gas generated during formation of the vehicle battery cell 102. The degas chamber 104 may include a knife 116, which may be any suitable sharp point, object, etc. for puncturing the pouch of the vehicle battery cell 102 to release gas sealed in the pouch into the degas chamber 104.

A vacuum pump 108 is in fluid communication with the degas chamber 104. Fluid communication may refer to one or more connections via a pipe, tube, gas flow line, etc., which allows gas to flow from one component to another. The vacuum pump 108 may be configured to remove air from the degas chamber 104 (e.g., by creating a vacuum in the degas chamber 104), which may facilitate drawing vehicle battery cell gas out of the pouch and into the degas chamber 104.

As shown in FIG. 1, a gas detector 110 is coupled along the gas flow line from the degas chamber 104 to the vacuum pump 108. The gas detector 110 may be in fluid communication with the degas chamber 104, in order to analyze at least a portion of the gas released from the vehicle battery cell 102.

For example, the gas detector 110 may be configured to detect at least one parameter of the gas of the vehicle battery cell 102 with gas species separation (e.g., the gas detector 110 may be configured to identify more than one gas component within a gas mixture released from the pouch of the vehicle battery cell 102). The at least one parameter may include for example, presence of one or more types of gas, amounts or concentrations of one or more types of gas, signatures or gas signals of one or more types of gas present in the mixture released by the vehicle battery cell 102, etc.

The parameter(s) of the gas of the vehicle battery cell 102 analyzed by the gas detector 110 may be indicative of a manufacturing quality of the vehicle battery cell 102. For example, some types of gas present in the gas mixture released by the vehicle battery cell 102 may indicate that the formation process for the vehicle battery cell 102 did not complete successfully, and the vehicle battery cell 102 should not be included in a newly manufactured vehicle. Similarly, amounts/volumes/concentrations of specific types of gas may be indicative of improper formation of the vehicle battery cell 102, certain signals or gas composition signals may indicate improper formation of the vehicle battery cell 102, etc.

As shown in FIG. 1, the gas analysis system 100 may include other components for analyzing gas released from a pouch of the vehicle battery cell 102. For example, a venting port 114 may selectively vent the degas chamber 104 to ambient air adjacent to the degas chamber 104 (e.g., allow air to flow out of the degas chamber 104 into an external environment around the degas chamber 104, allow air from outside the degas chamber 104 to flow into the degas chamber 104, etc.).

One or more valves 112 may be located throughout the gas analysis system 100, such as on gas flow lines, pipes, tubes, etc., to selectively control flows of gas in the gas analysis system 100. For example, a valve 112 may be coupled between the degas chamber 104 and the gas detector 110, to selectively control a flow of gas of the vehicle battery cell 102 from the degas chamber 104 to the gas detector 110.

The degas chamber 104 may include a heat seal bar 118. The heat seal bar 118 may be configured to re-seal the pouch of the vehicle battery cell 102 after the gas has been released from the vehicle battery cell 102 due to puncturing of the pouch by the puncturing knife 116.

In various implementations, a constriction portion or a pressure control valve (such as a needle valve) can be used to reduce operating pressure of the gas flowing to the gas detector 110, to acceptable pressure levels for the gas detector 110 to properly detect and analyze gas species components of the gas of the vehicle battery cell 102.

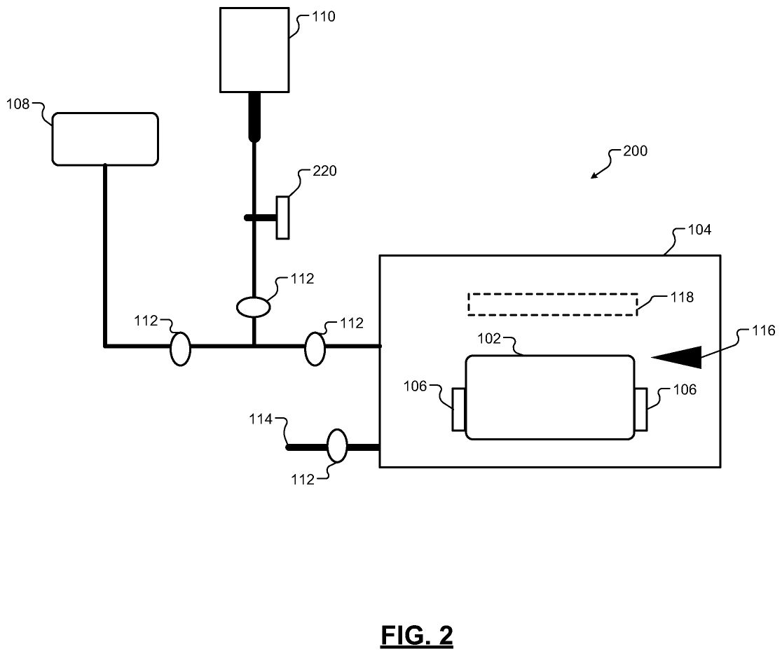

For example, FIG. 2 is a functional block diagram of an example embodiment of a gas analysis system 200 for vehicle battery cells, including a needle valve 220. Similar to FIG. 1, the gas analysis system 200 includes a degas chamber 104 housing a vehicle battery cell 102, and a puncturing knife 116 configured to puncture a pouch of the vehicle battery cell 102 to release a gas of the vehicle battery cell 102 into the degas chamber 104.

A vacuum pump 108 is in fluid communication with the degas chamber 104 to remove air from the degas chamber 104, which may facilitate removing gas from the pouch of the vehicle battery cell 102 and flowing the gas out of the degas chamber towards the gas detector 110.

In some example embodiments, the gas detector 110 may be configured to provide a desired gas detection level, desired gas analysis accuracy, etc., when a pressure of gas flowing to the gas detector 110 is below a specified pressure threshold level. The needle valve 220 may be coupled between the degas chamber 104 and the gas detector 110 (e.g., along a flow direction of gas from the degas chamber 104 to the gas detector 110).

The needle valve 220 may be configured to reduce a pressure of the gas of the vehicle battery cell 102 flowing to the gas detector 110. For example, a flow regulation setting, pressure setting, etc. of the needle valve 220 may be selected such that a pressure of gas flowing to the gas detector 110 is below the specified pressure threshold level for desired gas detection/analysis accuracy of the gas detector 110.

In another example embodiment, the gas detector 110 may be connected to a gas sample chamber that is filled over a short period of time after the pouch of the vehicle battery cell 102 is punctured. For example, once the detector analysis is complete, the system may decide to run the sample gas through an additional suite of sensors for confirmation of the classification of the vehicle battery cell 102 as conforming or non-conforming.

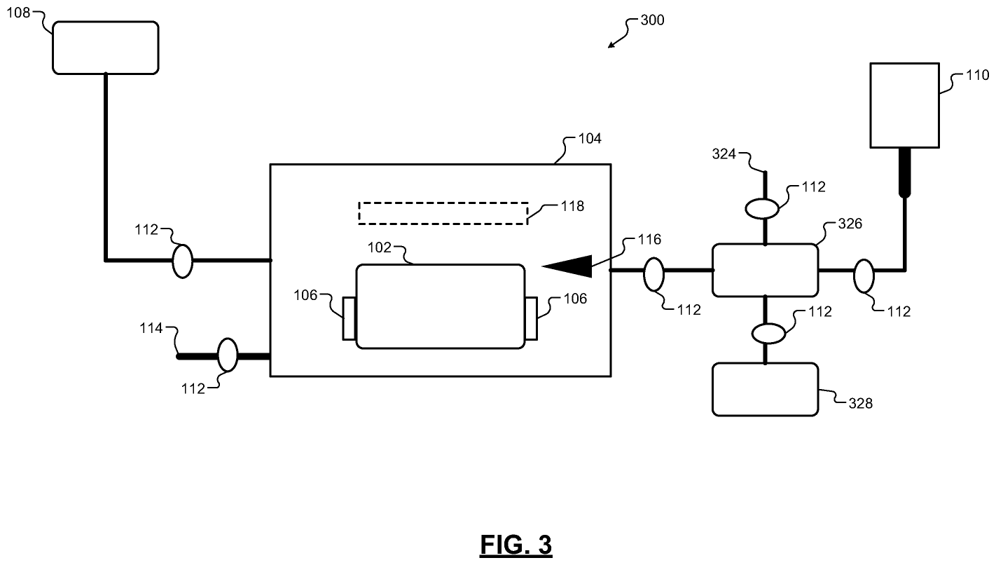

FIG. 3 is a functional block diagram of an example embodiment of a gas analysis system 300 for vehicle battery cells including a sample gas storage chamber 326 and a sensor suite 328. Similar to FIG. 1, the gas analysis system 300 includes a degas chamber 104 housing a vehicle battery cell 102, and a puncturing knife 116 configured to puncture a pouch of the vehicle battery cell 102 to release a gas of the vehicle battery cell 102 into the degas chamber 104. A vacuum pump 108 is in fluid communication with the degas chamber 104 to remove air from the degas chamber 104, which may facilitate removing gas from the pouch of the vehicle battery cell 102.

As shown in FIG. 3, the sample gas storage chamber 326 is coupled between the degas chamber 104 and the gas detector 110. The sample gas storage chamber 326 may receive the gas of the vehicle battery cell 102 prior to the gas of the vehicle battery cell 102 flowing to the gas detector 110.

A gas flow line may extend from the sample gas storage chamber 326 to at least one sensor other than the gas detector 110. For example a sensor suite 328 may be in fluid communication with the sample gas storage chamber 326 via the gas flow line.

The sensor suite 328 may include one or more additional gas detectors to detect the same or other parameters of the gas of the vehicle battery cell 102, compared to the gas detector 110. For example, the sensor suite 328 may be used to confirm initial analysis performed by the gas detector 110, to detect other features of the gas of the vehicle battery cell 102 that the gas detector 110 is not designed to detect, etc. Detectors of the sensor suite 328 may also be capable of using gas species separation when analyzing the gas of the vehicle battery cell 102.

As shown in FIG. 3, the sample gas storage chamber 326 is in fluid communication with a purge air line 324. The purge air line 324 may be configured to supply air to clean the gas detector 110, after the gas detector 110 analyzes the gas of the vehicle battery cell 102.

In another example embodiment, the system may include a gas handling module configured to dilute the gas of the vehicle battery cell 102, and flow the gas past a sensor suite (such as the sensor suite 328 of FIG. 3), which includes one or more gas detectors having gas species resolution capabilities, before exhausting the gas out of a port. The gas sample chamber may have a removable sample bottle port for additional analysis.

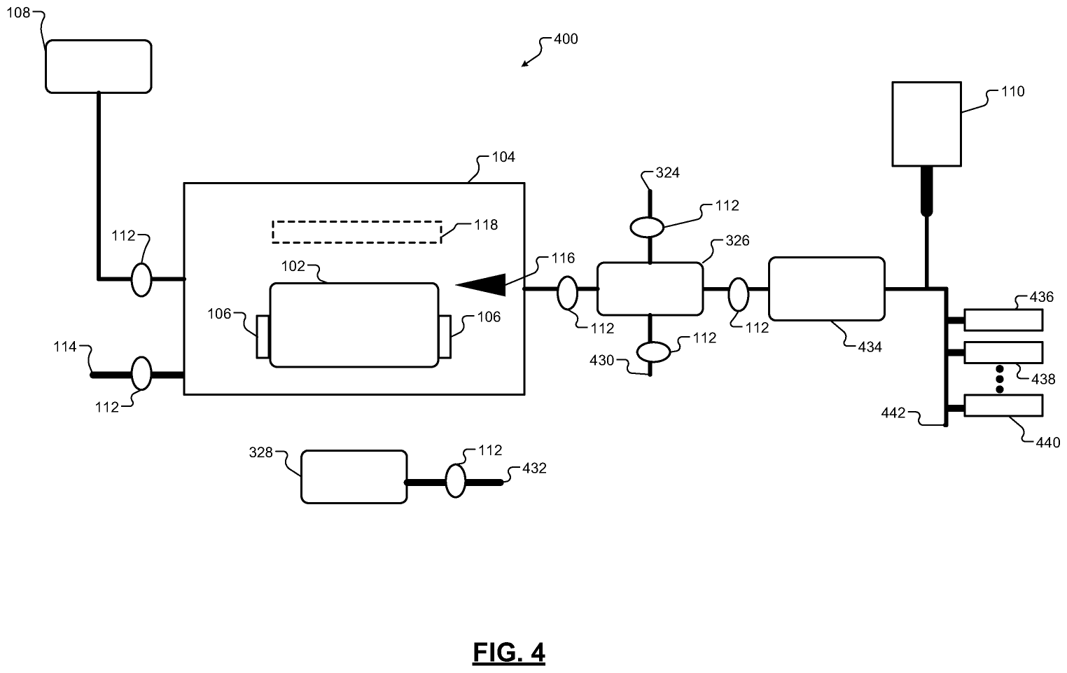

For example, FIG. 4 is a functional block diagram of an example embodiment of a gas analysis system 400 for vehicle battery cells, including a removable sample bottle port. Similar to FIG. 1, the gas analysis system 400 includes a degas chamber 104 housing a vehicle battery cell 102, and a puncturing knife 116 configured to puncture a pouch of the vehicle battery cell 102 to release a gas of the vehicle battery cell 102 into the degas chamber 104.

A vacuum pump 108 is in fluid communication with the degas chamber 104 to remove air from the degas chamber 104, which may facilitate removing gas from the pouch of the vehicle battery cell 102.

As shown in FIG. 4, the sample gas storage chamber 326 is in fluid communication with a sample bottle port 430. For example, the sample bottle port 430 may be configured to facilitate removably coupling a sample bottle to the sample bottle port 430 (e.g., via threads, via a friction fit, via an adjustable valve, etc.), to flow the gas of the vehicle battery cell 102 into the sample bottle.

Once the sample bottle receives at least a portion of the gas of the vehicle battery cell 102, the sample bottle may be removed to test the gas of the vehicle battery cell 102 at another location, such as a receiving port 432 in fluid communication with a sensor suite 328.

The gas analysis system 400 includes a gas handling and distribution system 434, in fluid communication with the sample gas storage chamber 326. The gas handling and distribution system 434 is configured to receive the gas of the vehicle battery cell 102 from the degas chamber 104 (e.g., via the sample gas storage chamber 326), and flow the gas of the vehicle battery cell 102 past one or more sensors.

For example, as shown in FIG. 4, the gas handling and distribution system 434 flows the gas of the vehicle battery cell 102 past a first sensor 436, a second sensor 438, up to an N-th sensor 440, and out of an exhaust port 442. Each sensor may be configured to detect a different parameter or multiple parameters of the gas of the vehicle battery cell 102.

In yet another example embodiment, the gas detector 110 may be connected directly to the degassing chamber with a valve, so that the analysis of the gas is completed as the chamber is pumping down, reducing the integration complexity and the impact on the degassing system.

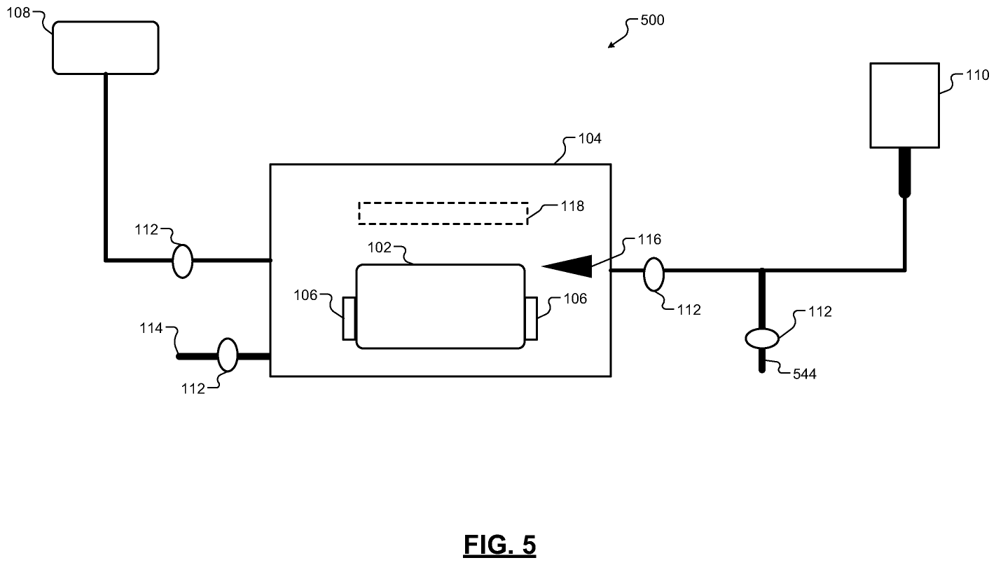

For example, FIG. 5 is a functional block diagram of an example embodiment of a gas analysis system 500 for vehicle battery cells, where the gas detector 110 is connected directly to the degas chamber 104 via a valve 112 (which may be configured to selectively open and close based on a control signal, etc.).

Similar to FIG. 1, the gas analysis system 500 includes a degas chamber 104 housing a vehicle battery cell 102, and a puncturing knife 116 configured to puncture a pouch of the vehicle battery cell 102 to release a gas of the vehicle battery cell 102 into the degas chamber 104.

A vacuum pump 108 is in fluid communication with the degas chamber 104 to remove air from the degas chamber 104, which may facilitate removing gas from the pouch of the vehicle battery cell 102. As shown in FIG. 5, the system includes a purge air line 544 in fluid communication with the degas chamber 104.

In various implementations, the gas detector 110 may be in fluid communication with a gas sampling tube extending into the degas chamber 104. The gas sampling tube may include an opening adjacent a puncture location of the pouch of the vehicle battery cell 102. This arrangement may increase the amount of gas of the vehicle battery cell 102 that flows out of the pouch and directly to the gas detector 110. In some example embodiments, multiple tubes may be placed along the puncture location to sample gas, such as when the cell gas pouch has one dimension that is substantially longer than the other, which may be another approach to increase the amount of gas that flows to the gas detector 110.

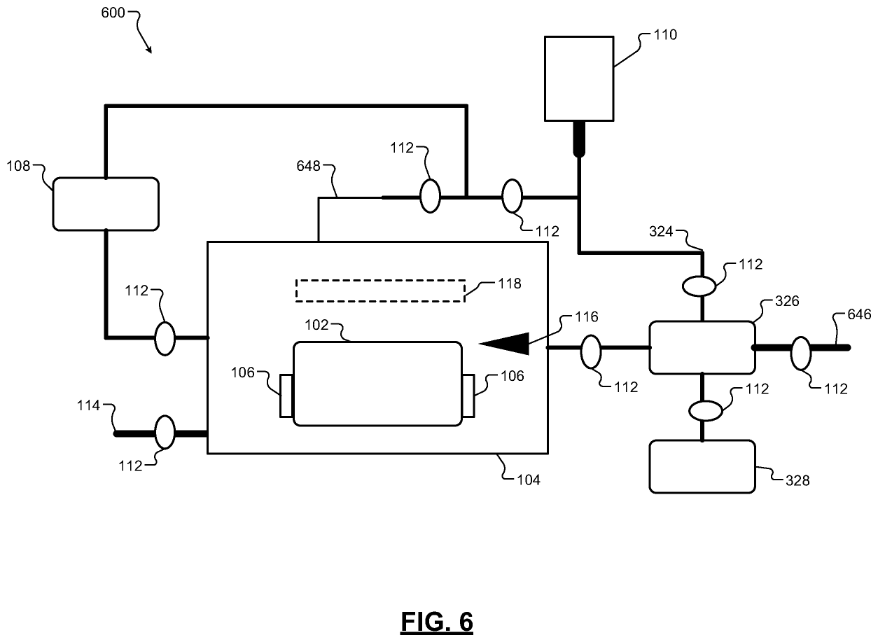

FIG. 6 is a functional block diagram of an example embodiment of a gas analysis system 600 for vehicle battery cells, including a constriction line. Similar to FIG. 1, the gas analysis system 600 includes a degas chamber 104 housing a vehicle battery cell 102, and a puncturing knife 116 configured to puncture a pouch of the vehicle battery cell 102 to release a gas of the vehicle battery cell 102 into the degas chamber 104.

A vacuum pump 108 is in fluid communication with the degas chamber 104 to remove air from the degas chamber 104, which may facilitate removing gas from the pouch of the vehicle battery cell 102. As shown in FIG. 6, the system includes a purge air line 646 in fluid communication with the degas chamber 104, via the sample gas storage chamber 326.

As shown in FIG. 6, a constriction channel 648 is located between the degas chamber 104 and the gas detector 110. The constriction channel 648 may have a diameter which is less than other gas flow lines in the gas analysis system 600. The constriction channel 548 may be configured to reduce a pressure of the gas of the vehicle battery cell 102 flowing to the battery cell.

In the gas analysis system 600, the gas detector 110 is in fluid communication with the degas chamber 104 via multiple gas flow lines, which are separate from one another. As mentioned above, the gas detector 110 may include any suitable sensor, such as a mass spectrometer, a gas chromatography system, and an infrared absorption spectroscopy system.

In some example embodiments, a gas analysis system may operate by, after the pouch of the vehicle battery cell 102 is punctured, flowing gas to the gas detector 110. The gas detector 110 may be configured to display, output, etc., various gas composition peaks based on the constituent gasses in the sample gas received from the vehicle battery cell 102.

A classifying algorithm may be used to label the cell as conforming, non-conforming, suspect, etc. The algorithm may include a machine learning model, another process such as principal component analysis, etc. Based on the design of the vehicle battery cell manufacturing system, additional testing may be performed on vehicle battery cells identified as suspect or non-conforming according to the gas analysis. The system may then be cleaned via a pump down, a purge air flow line, etc., in preparation for analysis of gas from a next vehicle battery cell.

In some example embodiments, such as when using RGA or IR absorption detectors, the system may first load the vehicle battery cell into the degas chamber. The system may then start a time series acquisition of spectra or monitoring of specific elements of the gas of the vehicle battery cell.

The system punctures the pouch of the vehicle battery cell, and then monitors peak heights of specific gases in the gas mixture of the vehicle battery cell. After monitoring, the system may pump the degas system down, and then seal the vehicle battery cell. The degas chamber is vented to clean the chamber of residual gas, and the system may output a quality label for the vehicle battery cell based on analysis of the gas spectra as detected by the gas detector.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A battery cell gas analysis system comprising:
a degas chamber;
a vacuum pump in fluid communication with the degas chamber to remove air from the degas chamber;
a venting port configured to selectively vent the degas chamber;
a battery cell enclosed in the degas chamber;
a gas detector in fluid communication with the degas chamber, the gas detector configured to detect, with gas species separation, at least one parameter of a gas released from the battery cell into the degas chamber, the at least one parameter of the gas of the battery cell indicative of a manufacturing quality of the battery cell; and
at least one valve coupled between the degas chamber and the gas detector to selectively control a flow of the gas of the battery cell to the gas detector.

2. The battery cell gas analysis system of claim 1, wherein the battery cell is a pouch cell, and the battery cell gas analysis system further includes:
a puncturing knife configured to puncture a pouch of the battery cell to release a gas of the battery cell into the degas chamber; and
a heat seal bar configured to seal the pouch of the battery cell after release of the gas of the battery cell.

3. The battery cell gas analysis system of claim 1, further comprising at least one of a constriction channel and a pressure control value coupled between the degas chamber and the gas detector to reduce a pressure of the gas of the battery cell flowing to the gas detector.

4. The battery cell gas analysis system of claim 1, further comprising a sample storage chamber coupled between the degas chamber and the gas detector to receive the gas of the battery cell prior to the gas of the battery cell flowing to the gas detector.

5. The battery cell gas analysis system of claim 4, wherein the gas detector is a first gas detector, the battery cell gas analysis system further comprising:
a gas flow line extending from the sample storage chamber; and
a second gas detector in fluid communication with the gas flow line, the second gas detector configured to detect at least one parameter of the gas of the battery cell with gas species separation.

6. The battery cell gas analysis system of claim 4, further comprising a sample bottle port in fluid communication with the sample storage chamber, the sample bottle port configured to removably couple with a sample bottle to flow the gas of the battery cell into the sample bottle to remove at least a portion of the gas of the battery cell from the battery cell gas analysis system.

7. The battery cell gas analysis system of claim 4, wherein:
the gas detector is in fluid communication with the degas chamber via a first gas flow line;
the gas detector is in fluid communication with the sample storage chamber via a second gas flow line; and
the first gas flow line is separate from the second gas flow line.

8. The battery cell gas analysis system of claim 1, wherein:
the gas detector is in fluid communication with a gas sampling tube extending into the degas chamber; and
an opening of the gas sampling tube is adjacent to a puncture location of a pouch of the battery cell.

9. The battery cell gas analysis system of claim 1, further comprising a gas purge line in fluid communication with the gas detector to supply a purge gas to clean the gas detector after analyzing the gas of the battery cell.

10. The battery cell gas analysis system of claim 1, wherein the gas detector is a first gas detector, and the battery cell gas analysis system further comprises:
a sensor suite including one or more additional gas detectors configured to analyze the gas of the battery cell with gas species resolution; and
a gas handling module configured to receive the gas of the battery cell from the degas chamber and flow the gas of the battery cell past the sensor suite.

11. The battery cell gas analysis system of claim 1, wherein:
the gas detector is a first gas detector configured to detect a first parameter of the gas of the battery cell;
the battery cell gas analysis system includes a second gas detector in fluid communication with the degas chamber;
the second gas detector configured to detect a second parameter of the gas of the battery cell with gas species separation; and
the second parameter is different than the first parameter.

12. The battery cell gas analysis system of claim 1, wherein the gas detector includes a mass spectrometer.

13. The battery cell gas analysis system of claim 12, wherein the gas detector includes a gas chromatography system.

14. The battery cell gas analysis system of claim 13, wherein the gas detector includes an infrared absorption spectroscopy system.

15. A battery cell gas analysis system comprising:
a degas chamber;
a vacuum pump in fluid communication with the degas chamber to remove air from the degas chamber;
a battery cell enclosed in the degas chamber;
a gas detector in fluid communication with the degas chamber, the gas detector configured to detect at least one parameter of gas of the battery cell with gas species separation, the at least one parameter of the gas of the battery cell indicative of a manufacturing quality of the battery cell; and
at least one valve coupled between the degas chamber and the gas detector to selectively control a flow of the gas of the battery cell to the gas detector.

16. The battery cell gas analysis system of claim 15, wherein the gas detector includes at least one of a mass spectrometer, a gas chromatography system or an infrared absorption system.

17. The battery cell gas analysis system of claim 15, further comprising at least one of a constriction channel and a pressure control coupled between the degas chamber and the gas detector to reduce a pressure of the gas of the battery cell flowing to the gas detector.

18. The battery cell gas analysis system of claim 15, further comprising a sample storage chamber coupled between the degas chamber and the gas detector to receive the gas of the battery cell prior to the gas of the battery cell flowing to the gas detector.

19. A battery cell gas analysis system comprising:
a degas chamber;
a venting port configured to selectively vent the degas chamber;
a gas detector in fluid communication with the degas chamber, the gas detector configured to detect, with gas species separation, at least one parameter of a gas released from a battery cell into the degas chamber, the at least one parameter of the gas of the battery cell indicative of a manufacturing quality of the battery cell; and
at least one valve coupled between the degas chamber and the gas detector to selectively control a flow of the gas of the battery cell to the gas detector.

20. The battery cell gas analysis system of claim 19, wherein the gas detector includes at least one of a mass spectrometer, a gas chromatography system or an infrared absorption system.
